(19) United States
(12) Patent Application Publication
(10) Pub. No.: US 2019/0291852 A1
(43) Pub. Date: Sep. 26, 2019

(54) FLYING VEHICLE HYBRID POWER PLANT

(71) Applicant: Hoversurf, Inc., Burlingame, CA (US)

(72) Inventor: Aleksandr ATAMANOV, St. Petersburg (RU)

(73) Assignee: Hoversurf, Inc., Burlingame, CA (US)

(21) Appl. No.: 15/926,890

(22) Filed: Mar. 20, 2018

(51) Int. Cl. B64C 15/02; B64D 27/04; B64D 27/24; G05D 1/00; G05D 1/04; B64D 35/02

(52) U.S. Cl. CPC B64C 15/02; B64D 27/04; B64D 27/24; B64D 2027/026; G05D 1/042; B64D 35/02; G05D 1/0011

(57) ABSTRACT

A system and method for operating a flying vehicle that includes a plurality of fan blades disposed on a first shaft. The shaft forms a rotor part of an electric motor. The shaft is coupled through a clutch assembly to a second shaft. The second shaft is coupled to a crankcase and to an internal combustion engine. The clutch assembly, motor and engine are all controlled by an on-board processor such that the processor controls the thrust provided by the fan blade by controlling operation of the motor and engine and clutch assembly. In operation the electric motor may be operated as a generator to recharge a power storage system. Moreover, a plurality of such hybrid-electric motors may be used to provide lift and propulsion for the flying vehicle.

### BACKGROUND

The invention relates to the field of aviation, namely, to flying vehicles (FV) for vertical take-off and landing (or “multicopter”). A multicopter, also called a multi-rotor helicopter or, in cases with four rotors, a quadrotor, is a helicopter that is lifted and propelled by more than one rotors. Conventionally, four or more rotors are used to increase stability and mobility. Multicopters are classified as rotorcraft, as opposed to fixed-wing aircraft, because their lift is generated by a set of vertically oriented propellers (rotors) instead of airflow across a wing.

Multicopters generally use identical fixed pitched propellers, but operating in tandem to increase stability. For example, counter-rotation increases stability by operating two clockwise and two counterclockwise rotating propellers. Conventionally, independent variation of the speed of each rotor is employed to achieve control. By changing the speed of each rotor it is possible to specifically generate a desired total thrust; to locate for the center of thrust both laterally and longitudinally; and to create a desired total torque, or turning force.

Multicopters differ from conventional helicopters, which use rotors that are able to vary the pitch of their blades dynamically as they move around the rotor hub. Torque-induced control issues, as well as efficiency issues originating from the tail rotor, which generates no useful lift, but requires energy, can be eliminated by counter-rotation, and the relatively short blades may make it easier to build.

Recent advances in electronics allowed for the production of affordable, lightweight flight controllers, accelerometers (IMU), global positioning system and cameras. This resulted in the multicopter configuration becoming popular for small unmanned aerial vehicles. Accordingly, multicopters are cheaper and more durable than conventional helicopters owing to their mechanical simplicity. Their smaller blades are also advantageous because they possess less kinetic energy, reducing their ability to cause damage and making the vehicles safer for close interaction. However, as size increases, fixed propeller multicopters develop disadvantages over conventional helicopters because increasing blade size increases their momentum. This means that changes in blade speed take longer to effectuate, which negatively impacts control. Conventional helicopters do not experience this problem as increasing the size of the rotor disk does not significantly impact the ability to control blade pitch.

### SUMMARY

Disclosed herein is a system and methods for operating a flying vehicle that includes a plurality of fan blades disposed on a first shaft. The shaft forms a rotor part of an electric motor. The shaft is coupled through a clutch assembly to a second shaft. The second shaft is coupled to a crankcase and to an internal combustion engine. The clutch assembly, motor and engine are all controlled by an on-board processor such that the processor controls the thrust provided by the fan blade by controlling operation of the motor and engine and clutch assembly. In operation the electric motor may be operated as a generator to recharge a power storage system. The clutch assembly, motor and engine collectively form an embodiment of a hybrid-electric thrust source. Accordingly, a plurality of such hybrid-electric thrusters may be used to provide lift and propulsion for the flying vehicle.

Disclosed herein are systems and methods for operating a flying vehicle that includes a vehicle having a plurality of hybrid-electric motors, each of said motors coupled to a rotor and a motor controller; at least one sensor coupled to either the plurality of motors or the rotors, said sensor operative to sense an operating characteristic of the rotor or motor based on a predetermined setpoint; a processor, said processor coupled to a memory and to said motor control circuitry and said sensors, said processor operable to; receive a signal from the sensor; determine a predetermined operational procedure in response to the signal, and alter the operating characteristics of one or more hybrid-electric motors, wherein the signal may indicate a failure condition or another type of operational condition to allow the processor to control the vehicle procedure in response to the signal condition.

Various sensors may be employed, together with different power sources to effectuate emergency flying procedures in the event a malfunction in a rotor, motor or motor controller. Setpoints for the sensors may be preprogrammed to effectuate detection of failure events. The operational procedures may be selected depending on the sensor input and put into operation in a manner to counter-act the anticipated results of the failure condition.

The construction and method of operation of the invention, however, together with additional objectives and advantages thereof will be best understood from the following description of specific embodiments when read in connection with the accompanying drawings and claims.

### BRIEF DESCRIPTION OF THE DRAWINGS

FIG. 1 shows a functional block diagram of a first embodiment of certain aspects of a flying vehicle according to the current disclosure.

FIG. 2 illustrates a conceptual drawing of a hybrid electric motor showing a cutaway portion exposing the fan blades.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

### Processing System

The methods and techniques described herein may be performed on a processor based device. The processor based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system, or sensors, and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor(s) contemplates that the methods disclosed herein will also operate over a network such as the Internet, and may be effectuated using combinations of several processing devices, memories and I/O. Moreover any device or system that operates to effectuate techniques according to the current disclosure may be considered a server for the purposes of this disclosure if the device or system operates to communicate all or a portion of the operations to another device.

The processing system may include communications devices such as a wireless transceiver. These wireless devices may include a processor, memory coupled to the processor, displays, keypads, WiFi, Bluetooth, GPS and other I/O functionality. Alternatively, the entire processing system may be self-contained on a single device in certain embodiments.

The methods and techniques described herein may be performed on a processor based device. The processor based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touchscreens, displays, as well as remote connected computer systems.

### System Components

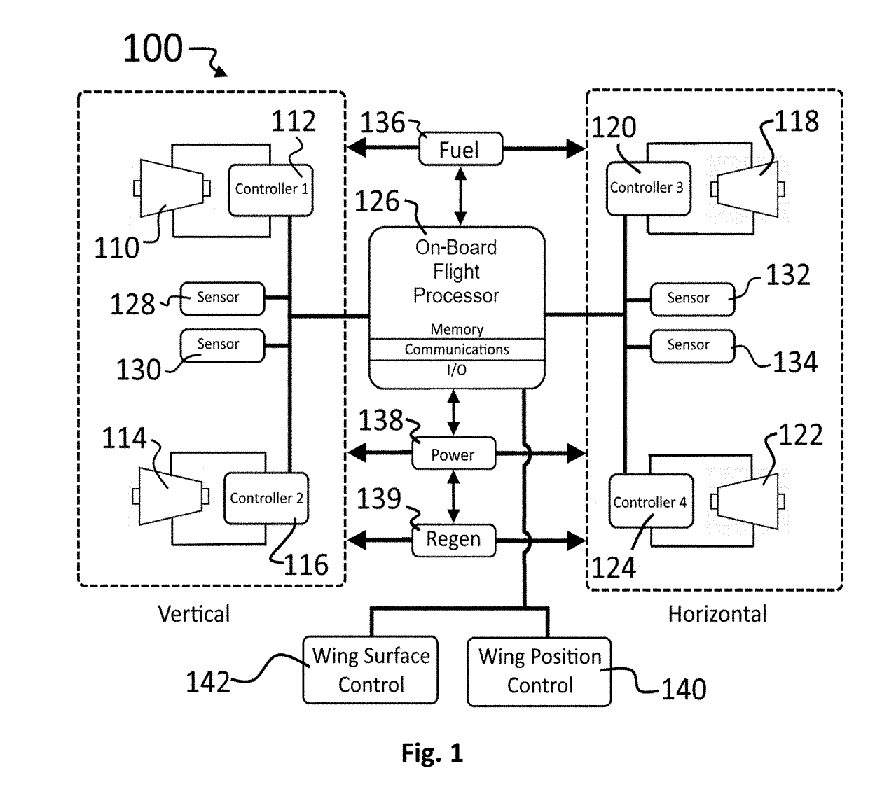

FIG. 1 shows a functional block diagram of a first embodiment of certain aspects of a flying vehicle according to the current disclosure. In FIG. 1 a flying vehicle represented as having two sets of hybrid electric motors 110, 114, 118, and 124, each attached to a motor controller 112, 116, 118, and 124 as shown. One set of hybrid electric motors (112 and 116) are disposed in the flying vehicle to provide vertical thrust, while the other set 118 and 122 are disposed to provide horizontal thrust. While only two hybrid electric motors are depicted in each set, the inventors contemplate using different numbers and arrangements of hybrid electric motors. For example, and without limitation, the vertical set may include 8 hybrid electric motors while the horizontal set includes only two hybrid electric motors. The number and size of the hybrid electric motors will be determined by the payload requirements of the flying vehicle.

The hybrid electric motors as disclosed herein are hybrids which include both an internal combustion engine and electrical motors, both coupled to a single shaft. The hybrid electric motors are each attached to controllers 12, 116, 118, and 122 for providing variable power to the hybrid electric motors under the control of an on-board flight processors 126. To effectuate power usage multiple power sources are used. For the electric motor, batteries, 138 or solar convertors (not shown) may be employed. Fuel 136 and throttle information is also supplied to the internal combustion engines under control of the on-board processor 126. In different embodiments these power sources may operate independently powering different operations, operate in tandem, or provide power under the control of the on-board flight processor 126. For example, and without limitation an internal combustion engine may provide lift while an electric motor provides horizontal propulsion.

The on-board flight processor 126 is coupled to memory, input-output (I/O) devices, and communications systems such as wireless radio, Bluetooth, GPS receiver, and the like. The wireless communications may include a link for controlling the flying vehicle from a remote operator or, in some embodiments the pre-planned flight may be stored in memory and used by the processor 126 to control flight.

Sensors 128, 130, 132, and 134 are coupled to the on-board flight processor 126. Depending on the nature of these sensors they may also be coupled to one or more of the controllers, the motors power supply, or other electro-mechanical assembly. The types and operation of the sensors may be pre-selected for specific flight characteristics. For example, and without limitation, sensors employed may include:
Vibration sensors for detecting motor vibration
Level sensors for detecting pitch, yaw and roll
Current sensors for detecting current of a motor or motor controller
Back-electromotive force (EMF) sensors for sensing motor operation
Tachometers for sensing speed of motor rotation
Power sensors for sensing power supplied to a motor or controller
Barometers for sensing change in altitude
Gyroscopes for sensing spin
Accelerometers for sending flying vehicle motion
Power sensors for measuring power storage information.
   To accurately sense meaningful information, the sensors must operate with a high degree of sensitivity, however, the sensitivity of the sensors, the type of sensors, and the quantity of sensors may all be selected on a flight-by-flight basis, thus allowing for a user to set equipment for a desired result. Moreover, each sensor may require information to predetermine whether the sensed parameter is operating within an acceptable range. For example, and without limitation, since vibration is to be expected during flight, the sensor may be pre-adjusted to only indicate when the vibration exceeds a certain setpoint.

Further coupled to the power source and on-board flight processor 126 are wing surface controls 138 and wing position controls 140. The wing surface controls control operation of the wings, including, but not limited to, ailerons, flaps, spoilers, and other control surfaced used to operate the vehicle in flight. Since these surfaces are under control of the processor 126, they may be operated to perform a preprogrammed flight or in response to signals received through the communications subsystem. Conventional flight operations may be performed in conjunction with the vertical thrust subsystem 138 and the wing position control subsystem 140.

Also coupled to the processor 126 is a wing position control 140 which provides for a dynamic wing that has a moveable profile. The wings are hinged and coupled to an actuator that shifts the wings during operation. This effectuates a change in the angle of attack of the entire wing and may increase the lift or other operations. Wing surface control 142 may be effectuated using conventional technology. Flap, rudder, spoiler and aileron controls using conventional “fly-by-wire” technology to operate electric motors for these control surface are readily available. Wing position control 140 may effectuate operations on a folding, or double folding wing.

A regeneration circuit 139 is coupled to both the power supply 138 and the controllers 110, 114, 120, and 124. The regeneration circuit 139 provides for charging a battery or other electrical power storage system when the internal combustion engine is operating. The regeneration 139 is effectuated by driving the shaft disposed in the induction motor, in effect, operating the electric motor as a generator and routing the power derived to power storage 138. A regular AC induction motor usually can be used as a generator, without any internal modifications. Coupling the power generated to the power supply may be effectuated using convention battery charging circuitry.

Some embodiments may employ flight control technology and structural materials to tailor the aerodynamics and structure of aircraft, which may remove the need for variable sweep angle to achieve the required performance; instead, wings are given computer-controlled flaps on both leading and trailing edges that increase or decrease the camber or chord of the wing automatically to adjust to the flight regime.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### Operation

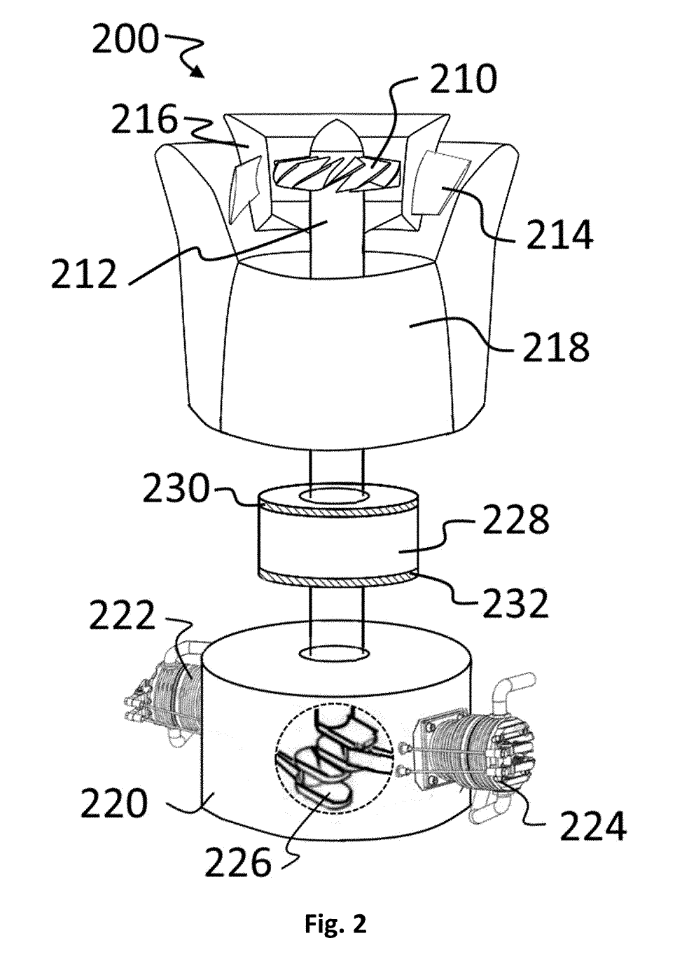

FIG. 2 illustrates a representation of hybrid electric motor 200 showing a cutaway portion exposing the fan blades. In FIG. 2 interior fan blades 210 are mounted to a central shaft 212. Secondary fan blades 214 are mounted to an interior duct 216. The interior duct 216 is also mounted to the shaft 212. Surrounding the shaft 212 is a variable-speed electric motor 218 (shown closed) operable for driving the shaft 212 causing the fans to rotate and generate thrust. A cowling 218 covers the exterior of a portion of the assembly 200. In certain embodiments, a conventional aircraft propeller, attached to the shaft, may be employed to generate thrust.

The shaft 212 extends out from the electric motor 218 into a crankcase 220. The crankcase includes couplings that connect the shaft 212 to internal combustion engines 222 and 224. (The inventor contemplates using four of more engines, however, only two are shown for clarity.) The coupling may be a conventional crankshaft 226 (shown in partially exposed view) to allow all the internal combustion engines to drive the shaft 212 simultaneously. An on-board processor may control the fuel and the timing of the engines to control the amount of thrust generated.

### Tandem Operation

Tandem operation of both the electric motor and the internal combustion engines may require both control of an on-board processor and mechanical coupling of the shaft to both power sources. The shaft may be coupled with a clutch assembly 228 to allow for disengagement of the internal combustion engine and the motor when appropriate. For clutching operation, electric motors, when unpowered, do not supply any force on the shaft. Accordingly, the engine must apply force to the shaft. However, when the electric motor is applying power to the shaft, the engine may cause drag on the central shaft 212. Clutches, or other mechanism such as free wheel clutches may provide for more synchronization between the engine and motor. The clutch 228 is coupled to an on-board processor through a servo or other conventional clutch controller.

In some embodiments the clutch assembly 228 includes tachometers 230 and 232 for sensing rotation of the shafts attached to the clutch assembly 228. The shaft portion extended into the electric motor 218 may be sensed by tachometer 230, while the shaft portion that extends into the crankcase 220 is sensed by a second tachometer 232. Both tachometers 230 and 232 provide tach information to the on-board processor.

In operation, the processor may engage or disengage the clutch as needed. Moreover, the processor may synchronize engagement of the clutch 228 with control of the engine and motors to effectuate the most efficient operation. For example, and without limitation, certain embodiments may allow for controlling the shaft rotation at a predetermined RPM using the electric motor and then engaging the clutch when the internal combustion engine approaches that RPM.

In certain embodiments a differential may be employed to prevent and the engines and motors from operating in opposition. Moreover, the use of a differential between engine cylinder pistons may allow for asynchronous operation of the internal combustion engines.

In some embodiments the shaft 212 may be split and coupled with a coaxially coupled free hub, a mechanism that locks when spinning in one direction, (forcing the shaft 212 to be driven by the engine) and spins freely when the motor is the predominant driver of the shaft 212. In this embodiment the parts of the shaft 212 will have largely uninhibited rotation when both the motor and the engines are operating. This may be useful in the case in which the shaft 212 is being driven by the engines 222 and 224 at a different speed than the electric motor is driving the shaft 212. In this manner, the two power sources can operate without driving the shaft in opposition.

In certain embodiments the processor may control the motor, engine and clutch assembly to provide a predetermined amount of thrust. The thrust amount may be in response to a preset flight characteristic. For example, and without limitation, a desired flight pattern may be programmed into system memory. The processor may then instruct the engine, clutch and motor to provide the maximum thrust for liftoff of the flying vehicle. Once a preset altitude is reached, the processor may dis-engage the engine so that only electric power is used for flight. Disengagement may be effectuated by powering off the engine and releasing the clutch. Alternatively, or in the event of a low battery indication, the engine and clutch assembly may be fully engaged and the electric motor left to “free wheel” the shaft.

### Power Generation

In some embodiments the internal combustion engines 222 and 224 may be operated without applying power to the electric motor 228. In this configuration, the motor 218 operates as a generator. Thus by powering the internal combustion engines, electrical power is generated for storage by a battery or similar electrical storage device. An on-board processor may direct the control of the engines to generate electrical power for storage when needed.

Battery power may be sensed using convention battery sense circuitry. The output from the battery sense circuit is then coupled to the on-board processor. When a low battery power indication is received at the processor, the processor may then direct electricity generated by the electric motor to the batteries for use in charging the batteries.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed:

1. A vehicle including:
a plurality of fan blades, said fan blades disposed on a first shaft;
an electric motor, said motor including the first shaft as a rotor portion;
an internal combustion engine, said engine coupled to a second shaft;
a clutch assembly, said clutch assembly operable to couple the first shaft and the second shaft;
a processor, said processor coupled to the electric motor, the internal combustion engine, and the clutch assembly;
wherein the processor is operable to control the power applied to the electric motor and the internal combustion engine.

2. The vehicle of claim 1 wherein the first shaft and the second shaft are aligned axially.

3. The vehicle of claim 1 further including:
a memory coupled to the processor, said memory including non-transitory program instructions operable to direct the processor to perform a method including the steps of:
receiving first shaft and second shaft rotation information, and
engaging the clutch assembly in response to the first and second shaft rotation information.

4. The vehicle of claim 1 further including:
a memory coupled to the processor, said memory including non-transitory program instructions operable to direct the processor to perform a method including the steps of:
receiving an indication of battery power from a battery sensor;
controlling the internal combustion engine and clutch assembly, in response to the indication of battery power, and
directing energy received from the electric motor to battery storage.

5. A thrust device including:
a plurality of fan blades, said fan blades disposed on a first shaft;
an electric motor, said motor including the first shaft as a rotor portion;
an internal combustion engine, said engine coupled to a second shaft;
a clutch assembly, said clutch assembly operable to couple the first shaft and the second shaft;
a processor, said processor coupled to the electric motor, internal combustion engine and the clutch assembly;
wherein the processor controls the electric motor, clutch assembly and internal combustion engine to effectuate a predetermined amount of thrust from the thrust device.

6. The device of claim 5 further including:
an altimeter coupled to the processor,
wherein the amount of thrust is sufficient to maintain a predetermined altitude.

7. The device of claim 5 further including:
an electrical storage device
an electrical storage sensors, said sensor operative to sense an amount of power in the electrical storage device;
wherein the processor controls the electric motor to generate power for storage in the storage device.

8. The device of claim 7 wherein said power generation is effectuated by engaging the first shaft to rotate using the internal combustion generator and the clutch assembly, and directing power induced into the motor windings to the electrical storage device.

9. A flying vehicle including:
a plurality of vertical hybrid-electric motors, said motors disposed about the flying vehicle for providing vertical thrust;
a plurality of horizontal hybrid-electric motors, said horizontal hybrid-electric motors disposed about the flying vehicle for providing horizontal thrust;
a processor, said processor coupled to the vertical hybrid-electric motors and he horizontal hybrid electric motors;
a memory coupled to the processor, said memory operable to hold non-transitory program instructions directing the processor to perform one or more methods, and
at least one sensor, said sensor coupled to the processor and operable to measure flight characteristic of the flying vehicle,
wherein the processor controls the hybrid-electric motors in response to the sensor information.

10. The vehicle of claim 9 wherein the sensors is an altimeter and the processor controls the hybrid-electric motors to maintain a predetermined altitude.

11. The vehicle of claim 9 further including:
A set of processor instructions encoded in non-transitory memory, said program instructions operable to direct the processor to perform a method including:
controlling the horizontal and vertical motors to fly a predetermined flight pattern, said controlling including receiving flight information from the sensor and operating the horizontal and vertical motors in response to the flight information.

12. The vehicle of claim 11 wherein the method further includes the steps of:
receiving flight control information from a remote wireless station, and controlling the vehicle in response to the flight control information.
